(19) United States
(12) Patent Application Publication
(10) Pub. No.: US 2010/0205376 A1
(43) Pub. Date: Aug. 12, 2010

(54) METHOD FOR THE IMPROVEMENT OF MICROPROCESSOR SECURITY

(75) Inventors: Ralf Malzahn, Seevetal (DE); Li Tao, Hamburg (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/666,927

(22) PCT Filed: May 9, 2008
(86) PCT No.: PCT/IB2008/051856

§ 371 Date: Dec. 28, 2009

(30) Foreign Application Priority Data
Jul. 5, 2007 (EP) 07111832.7

(51) Int. Cl. G06F 12/08; G06F 12/00; G06F 12/14

(52) U.S. Cl. 711/125; 711/163; 711/E12.001; 711/E12.02; 711/E12.098

(57) ABSTRACT

A method for the improvement of the security of microprocessors (1) with a cache memory (3, 4), whereas with a cache-instruction data can be written into the cache memory (3, 4), is improved to enhance the security of a system by inhibiting the direct writing of the cache-instruction into the cache memory (3, 4).

### FIELD OF THE INVENTION

The present invention relates to a method for the improvement of the security of microprocessors with a cache memory, whereas with a cache-instruction data can be written into the cache memory.

### BACKGROUND OF THE INVENTION

Microprocessors with a main memory and a cache memory are well known in the state of the art. The cache memory serves as a data storage for frequently needed data. The cache memory may store instructions for processing the data and/or the data itself.

For reading and/or writing data into such a cache memory the microprocessor supports so called cache-instructions with which the data can be handled. Such cache-instructions are typically used for a cache memory production test and for a initialisation of a system start-up for example to invalidate all of the cache-lines.

All microprocessors in communication with other microprocessors, computers and the like, for example via the Internet, are in danger of being infiltrated by unauthorised data, instructions, spyware and so on which is communicated by unauthorised persons called hacker. Thereto a hacker may use cache-instructions to manipulate cache contents for the purpose of an attack. He could write a code into an instruction cache which may reveal security-sensitive data. Preventing such an abuse is a main goal of microprocessor security.

### SUMMARY OF THE INVENTION

According to the aforementioned the present invention is directed to a method for the improvement of microprocessor security and to prevent an abuse of data or instructions stored in a cache memory of the microprocessor.

To achieve this object the direct writing of the cache-instructions into the cache memory is inhibited.

The core of the invention lies in the fact that a hacker no longer is able to manipulate the cache content since it is no more possible for him to directly write or change the cache-instruction which normally is written into the cache memory. It is clear that the direct writing into an instruction memory or instruction cache is inhibited as well as into a data cache. Inhibiting the direct writing into the cache ensures that only data will be loaded into the cache which are already present in the main memory of the system. If the main memory is implemented as a read-only memory (e.g. ROM or one-time-programmable FLASH) it can be ensured that no unwanted data can be taken into the cache.

Thereby the security of the whole system comprising such a microprocessor is enhanced in an easy way since the inhibiting of direct writing can be fulfilled by a person skilled in the art without any major amendments in hardware and/or software of the system. This can be executed in any order, preferably as described below.

A first method for inhibiting the direct writing of a cache-instruction into the cache memory contains the step of removing all related hardware support for these instructions. This requires minor amendments of the hardware of the microprocessor resulting in the invalidation of the execution of these instructions.

Alternatively the control flow may be marginally modified in one point of it. As an example could these instructions be removed from the list of instructions which are supported by an instruction decoder.

In a third embodiment also the hardware is altered by disconnecting certain control signal wires inside the instruction or data controller to prevent the writing of these cache-instructions.

If the cache-writing instructions are disabled as described above and still such an instruction is called by the user software, namely through a hacker, a reaction of the microprocessor can result in a software exception. That means that the running of the software is stopped and an error message can be transmitted. This can be executed by the instruction- or data-cache controller.

Another reaction of the microprocessor can be a total system reset or the shut down of the microprocessor.

Finally a one-cycle delay could be performed which is similar to a nop-instruction (no-operation).

These three aforementioned methods assure that no cache-instructions are written into the cache memory.

Nevertheless it still can be necessary to execute a cache memory production test and/or a system start-up initialisation. For this purpose dedicated hardware can be used to test/initialise cache Random Access Memories (RAM). Thereby the test and initialisation procedure is accelerated significantly. On the other hand the required chip-area of the microprocessor is slightly increased.

Alternatively the cache memory can be made up of electronic flip-flops. These flip-flops can be tested and reset via a scan-test. Such an assembly provides a very fast start-up speed but it introduces much chip-area overhead.

Furthermore the writing of cache-instructions into the cache during a production test and a system start-up phase can be enabled temporarily. This can be done with only minor modifications of the existing hardware and software. But a disadvantage lies in the fact that during this time an attack by a hacker is possible when he enables cache-writing instructions.

It is obvious that the methods as described above can be applied to all kinds of microprocessors supporting cache-writing instructions. Especially the methods should be applied in security-sensitive systems as smart-card controller integrated circuits.

### BRIEF DESCRIPTION OF THE DRAWING

An embodiment of the invention is described below. The drawing shows:

FIG. 1: a schematic cache-instruction execution flow.

### DETAILED DESCRIPTION OF THE DRAWING

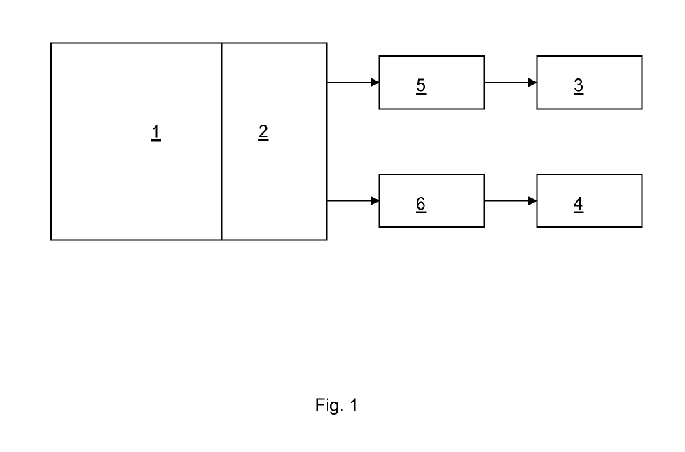

In FIG. 1 a microprocessor 1 receives a cache-writing instruction. The microprocessor 1 comprises an instruction decoder 2 for decoding the received instruction. Subsequently the decoded instructions are written in an instruction-cache memory 3 or a data-cache memory 4, as depicted with the fleshes. To prevent that any undesired instructions, especially such of a hacker, are written into the memories 3, 4 the write-access to these memories 3, 4 is controlled by a instruction-cache controller 5 or a data-cache controller 6 respectively which are intermediary to the memories 3, 4 and the microprocessor 1 or the instruction decoder 2.

In the controllers 5, 6 either all related hardware support is removed, minor modifications to just one point of the control flow is made or control signal wires inside the controllers 5, 6 are disconnected.

### LIST OF REFERENCES

1 microprocessor
2 instruction decoder
3 instruction-cache memory
4 data-cache memory
5 instruction-cache controller
6 data-cache controller

1. A method for the improvement of the security of microprocessors with a cache memory, whereas with a cache-instruction data can be written into the cache memory, characterised in that, the direct writing of the cache-instruction into the cache memory is inhibited.

2. The method according to claim 1, comprising the step of removing all related hardware support for these instructions.

3. The method according to claim 1, comprising the step of marginally modifying the control flow in one point of it.

4. The method according to claim 1, comprising the step of altering a hardware by disconnecting certain control signal wires inside an instruction or data controller.

5. The method according to claim 1, comprising the step that if such an instruction is called by a user software a software exception is produced.

6. The method according to claim 1, comprising the step that if such an instruction is called by a user software a total system reset is executed.

7. The method according to claim 1, comprising the step that if such an instruction is called by a user software a one-cycle delay is performed.

8. The method according to claim 1, comprising the step of the use of dedicated hardware to test/initialise cache Random Access Memories (RAM).

9. The method according to claim 1, comprising the step of making up the cache memory of electronic flip-flops.

10. The method according to claim 1, comprising the step of enabling temporarily the writing of cache-instructions into the cache during a production test and a system start-up phase.
